(19) United States
(12) Patent Application Publication
(10) Pub. No.: US 2019/0035526 A1
(43) Pub. Date: Jan. 31, 2019

(54) ADAPTER, TRANSFORMER, BOBBIN, AND ASSEMBLY METHOD OF TRANSFORMER

(71) Applicant: Chicony Power Technology Co., Ltd., New Taipei City (TW)

(72) Inventors: Po-Chien CHOU, New Taipei City (TW); Che-Shih LIN, New Taipei City (TW)

(21) Appl. No.: 15/725,256

(22) Filed: Oct. 4, 2017

(30) Foreign Application Priority Data
Jul. 28, 2017 (TW) 106125614
Aug. 22, 2017 (TW) 106128489

(51) Int. Cl. H01F 5/04; H01F 27/32; H01F 41/10

(52) U.S. Cl. CPC H01F 5/04; H01F 27/325; H01F 2005/043; H01F 2005/046; H01F 41/10

(57) ABSTRACT

A transformer includes a bobbin, a connection pin, a movable pin, a first and a second winding. The bobbin has two side walls between which a winding portion is arranged. A protruding plate extends from one of the side walls, a through hole is defined on the protruding plate, and the connection pin is arranged on the other side wall. The movable pin with a first and second latch portion is inserted in the through hole, the second latch portion is positioned in the through hole, and the first latch portion is arranged away from the protruding plate. The first winding is arranged on the winding portion and connected with the connection pin. The second winding is arranged on the winding portion and connected with the movable pin. Thereby, the transformer could be assembled in an automatic process, with low labor costs, improved assembly efficiency and high production yields.

### TECHNICAL FIELD

The present invention relates to a transformer structure and, in particular, to an adapter, a transformer, a bobbin, and an assembly method of the transformer.

### BACKGROUND

A transformer includes a bobbin, a magnetic core set, a primary winding and a secondary winding. The primary winding and the secondary winding are both constructed from multiple single-core wires twisted together (i.e. a stranded wire) to form coils. The primary winding and the secondary winding are wound around the bobbin and disposed at respective two sides of the bobbin. The magnetic core set is installed on the bobbin to surround the primary winding and the secondary winding. Electromagnetic action of the magnetic core creates a voltage at the primary winding, and then the voltage is output from the primary winding to be increased or decreased at the secondary winding.

The transformer is assembled to an adapter by the following methods. The adapter includes a circuit board and a current processing module. The current processing module is electrically connected to the circuit board. The current processing module includes a primary component and a secondary component. The transformer is assembled to the circuit board and is arranged between the primary component and the secondary component. The primary winding is electrically connected to the primary component, the secondary winding is electrically connected to the secondary component, the primary component performs a subsequent process on the current input by the primary winding, and the secondary component performs a subsequent process on the current output from the secondary winding.

However, the adapter and the transformer mentioned above have the following disadvantages. An end of the primary winding is directly welded to the circuit board. Current adapter is small-sized due to the product miniaturization trend. Therefore, the primary component is closer to the secondary component, leading to a reduced space left for welding the secondary winding. As a result, welding the secondary winding to the circuit board has to be done by manual labor, and no automated production processes can be used for this assembly. This causes high manual labor costs, poor assembly efficiency and low production yields.

In views of this, in order to solve the above disadvantages, the present inventor studied related technology and provided a reasonable and effective solution in the present disclosure.

### SUMMARY

The present invention provides an adapter, a transformer, a bobbin, and an assembly method of the transformer, whereby at least one movable pin is engaged where a first latch portion or a second latch portion is engaged, thus automated assembly of the adapter and the transformer can be achieved, with reduced manual labor costs, improved assembly efficiency and high production yields.

According to one embodiment, the present invention provides an adapter, comprising: a circuit board; a current processing module including a plurality of primary components and a plurality of secondary components installed and electrically connected to the circuit board; a shielding plate disposed between the primary components and the secondary components; and a transformer installed on the circuit board, the transformer comprising: a bobbin disposed at one side of the shielding plate, the bobbin including two side walls and a winding portion arranged between the two side walls, a protruding plate extending from one of the side walls and passing through the shielding plate, at least one through hole being defined on the protruding plate, a connection pin being arranged on the other side wall, the connection pin being inserted in the circuit board; at least one movable pin inserted through the through hole and inserted in the circuit board, the movable pin including a first latch portion and a second latch portion, the second latch portion being engaged and positioned in the through hole, the first latch portion being disposed adjacent to the circuit board; at least one first winding wound around the winding portion and connected to the connection pin; and at least one second winding wound around the winding portion and connected to the movable pin.

According to one embodiment, the present invention provides a transformer, comprising: a bobbin including two side walls and a winding portion between the two side walls, a protruding plate extending from one of the side walls, at least one through hole being defined on the protruding plate, a connection pin being arranged on the other side wall; at least one movable pin inserted in the through hole, the movable pin including a first latch portion and a second latch portion, the second latch portion being engaged and positioned in the through hole, the first latch portion being disposed away from the protruding plate; at least one first winding wound around the winding portion and connected to the connection pin; and at least one second winding wound around the winding portion and connected to the movable pin.

Moreover, a channel communicating with the inside of the winding portion passes through the two side walls, the channel is arranged below the protruding plate, the transformer includes an iron core set, a portion of the iron core set is inserted and engaged inside the channel, and another portion of the iron core set surrounds the exterior of the winding portion.

Moreover, the second latch portion is disposed above the first latch portion, the movable pin is disposed at one side of the iron core set, the first latch portion is a first pattern formed on the movable pin, and the second latch portion is a second pattern formed on the movable pin.

Moreover, the circuit board is divided into a primary area and a secondary area, the shielding plate is inserted and connected to the circuit board and is disposed between the primary area and the secondary area, the primary components and the connection pin are installed and electrically connected to the primary area, and the secondary components and the movable pin are installed and electrically connected to the secondary area.

Furthermore, the shielding plate includes a recess indented from a top of the shielding plate, and the protruding plate is engaged with the recess.

In addition, a wiring groove is disposed on a top of the protruding plate and arranged in a direction from the winding portion toward the through hole, two guiding blocks extend from the top of the protruding plate, and the wiring groove is formed between the two guiding blocks.

An assembly method of a transformer is provided according to one embodiment of the present invention, comprising the following steps: a) providing a bobbin which has two side walls and a winding portion between the two side walls, wherein a channel communicating with the inside of the winding portion passes through one of the side walls, a protruding plate extends from a top of this side wall, at least one through hole is defined on the protruding plate, and at least one connection pin is arranged on the other side wall; b) providing at least one movable pin which includes a first latch portion and a second latch portion, inserting the movable pin into the through hole until the first latch portion is engaged with the through hole; c) providing at least one first winding and at least one second winding, wherein the at least one first winding is wound around the winding portion and connected to the connection pin, and the at least one second winding is wound around the winding portion and connected to the movable pin; d) providing an iron core set, wherein a portion of the iron core set is inserted and engaged inside the channel, and another portion of the iron core set surrounds the exterior of the winding portion; and e) providing a fixture, the fixture further inserting the movable pin into the through hole until the first latch portion deforms or is damaged to release the movable pin, and the second latch portion is then engaged with the through hole.

In step b), the first latch portion is a first pattern formed on the movable pin, and the second latch portion is a second pattern formed on the movable pin. In step e), the second latch portion is disposed above the first latch portion, and the movable pin is arranged at one side of the iron core set.

According to one embodiment, the present invention provides a bobbin, comprising: two side walls and a winding portion between the two side walls, a protruding plate extending from one of the side walls, at least one through hole being defined on the protruding plate; and at least one movable pin inserted through the through hole, the movable pin including a first latch portion and a second latch portion, the second latch portion being engaged and positioned in the through hole, the first latch portion being disposed away from the protruding plate.

Moreover, the second latch portion is disposed above the first latch portion, the first latch portion is a first pattern formed on the movable pin, and the second latch portion is a second pattern formed on the movable pin.

Moreover, a wiring groove is disposed on a top of the protruding plate and arranged in a direction from the winding portion toward the through hole, two guiding blocks extend from the top of the protruding plate, and the wiring groove is formed between the two guiding blocks.

To sum up, the movable pin is inserted in the through hole and is positioned there by engagement of the first latch portion or the second latch portion with the through hole. The iron core set is assembled to the bobbin; the second winding is connected to the movable pin by means of welding or adhesives. The transformer is installed on the circuit board, the bobbin is disposed on the primary area, the protruding plate extends over the shielding plate to the secondary area, the first latch portion deforms or is damaged to release the movable pin, and the movable pin is then inserted in the secondary area. Thus, the adapter and the transformer can be assembled in an automatic process using a robot arm to complete the above procedures. Through the automatic process, manual labor costs are reduced, assembly efficiency is enhanced, and production yields are improved.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a diagram illustrating a process flow for an assembly method of a transformer according to the present invention;

FIG. 2 is a schematic view illustrating a portion of an iron core set is engaged in a channel according to the present invention;

FIG. 3 is a schematic view illustrating at least one movable pin to be inserted into a through hole;

FIG. 4 is a schematic view illustrating assembling of a transformer;

FIG. 5 is a schematic view illustrating assembling of an adapter;

FIG. 6 is another schematic view illustrating assembling of the adapter;

FIG. 7 is still another schematic view illustrating assembling of the adapter;

FIG. 8 is a schematic view illustrating assembling of the adapter;

FIG. 9 is an assembled view illustrating the transformer according to another embodiment of the present invention;

FIG. 10 is a cross-sectional view illustrating the transformer according to another embodiment of the present invention; and

FIG. 11 is another cross-sectional view illustrating the transformer according to another embodiment of the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

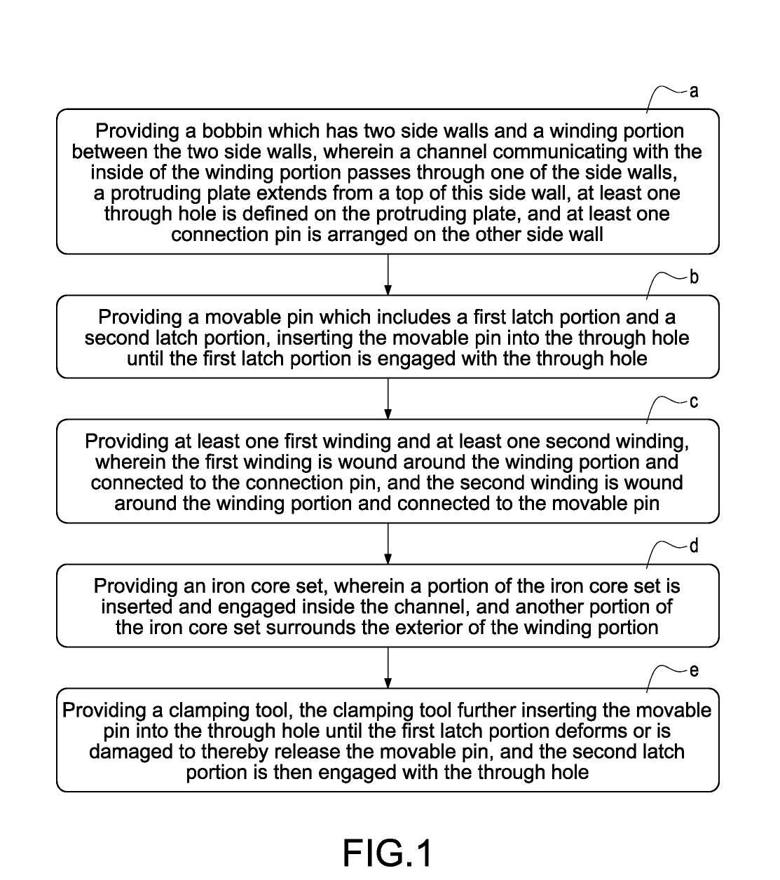

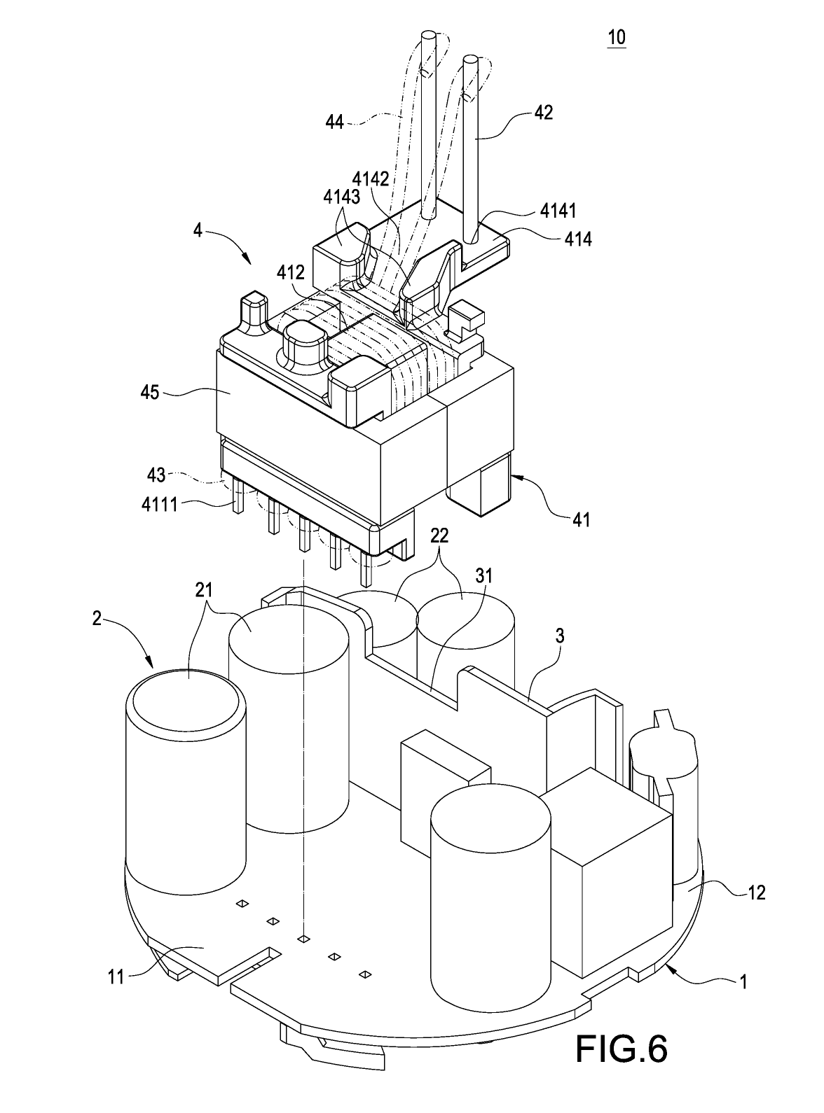

Referring to FIGS. 1 to 8, the present invention provides an adapter, a transformer, a bobbin and an assembly method of the transformer. The adapter 10 includes a circuit board 1, a current processing module 2, a shielding plate 3 and a transformer 4. The transformer 4 includes a bobbin 41, one or more movable pin 42, one or more first windings 43, and one or more second windings 44.

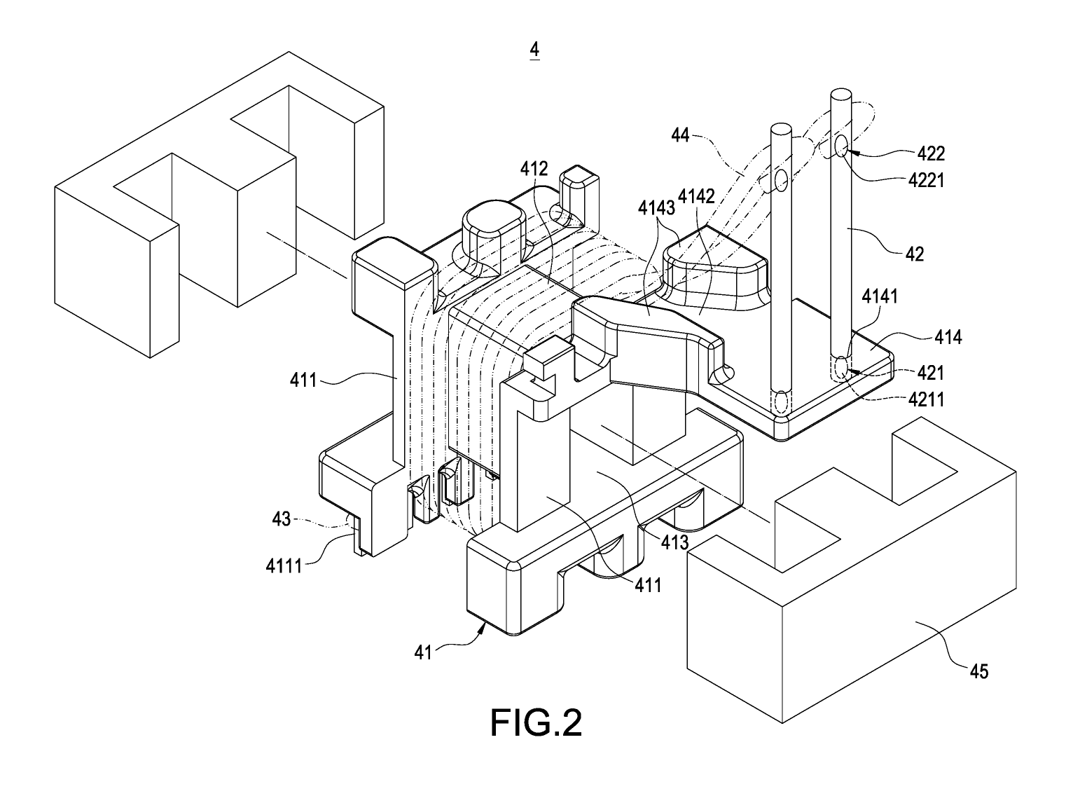

Please refer to FIG. 1 showing a process flow for an assembly method of the transformer 4. First, in step a of FIG. 1, shown in FIG. 2, a bobbin 41 is provided, the bobbin 41 including two side walls 411 and a winding portion 412 arranged between the two side walls 411. A channel 413 communicating with the inside of the winding portion 412 passes through one of the side walls 411, and a protruding plate 414 extending from a top of this side wall 411. That is to say, the channel 413 is arranged below the protruding plate 414. One or more through holes 4141 are defined on the protruding plate 414, and one or more connection pins 4111 are arranged on the other side wall 411.

In step b of FIG. 1, as shown in FIG. 2, one or more movable pins 42 are provided, the movable pin 42 including a first latch portion 421 and a second latch portion 422. The movable pin 42 is inserted into the through hole 4141, so that the first latch portion 421 is engaged and positioned in the through hole 4141.

In detail, in the present embodiment, the first latch portion 421 is a first pattern 4211 formed on the movable pin 42, and the second latch portion 422 is a second pattern 4221 formed on the movable pin 42. A width (or the diameter) of the movable pin 42 is substantially the same as the diameter of the through hole 4141. However, the width of the movable pin 42 varies at the first latch portion 421 and the second latch portion 422, so that the width (or the diameter) of the first latch portion 421 and the width of the second latch portion 422 are different from the diameter of the through hole 4141. Accordingly, the movable pin 42 is removably assembled to the through hole 4141 of the protruding plate 414. As one example, in the present embodiment, the largest width of the first pattern 4211 is larger than the diameter of the through hole 4141, and the largest width of the second pattern 4221 is larger than the diameter of the through hole 4141; however, the present embodiment is not limited in this regard. The first latch portion 421 and the second latch portion 422 can be adhesive or protruding points on the movable pin 42.

In step c of FIG. 1, as shown in FIG. 2, one or more first winding 43 and one or more second winding 44 are provided. The first winding 43 is wound around the winding portion 412 and is connected to the connection pin 4111 by means of welding or adhesives, and the second winding 44 is wound around the winding portion 412 and is connected to the movable pin 42 by means of welding or adhesives.

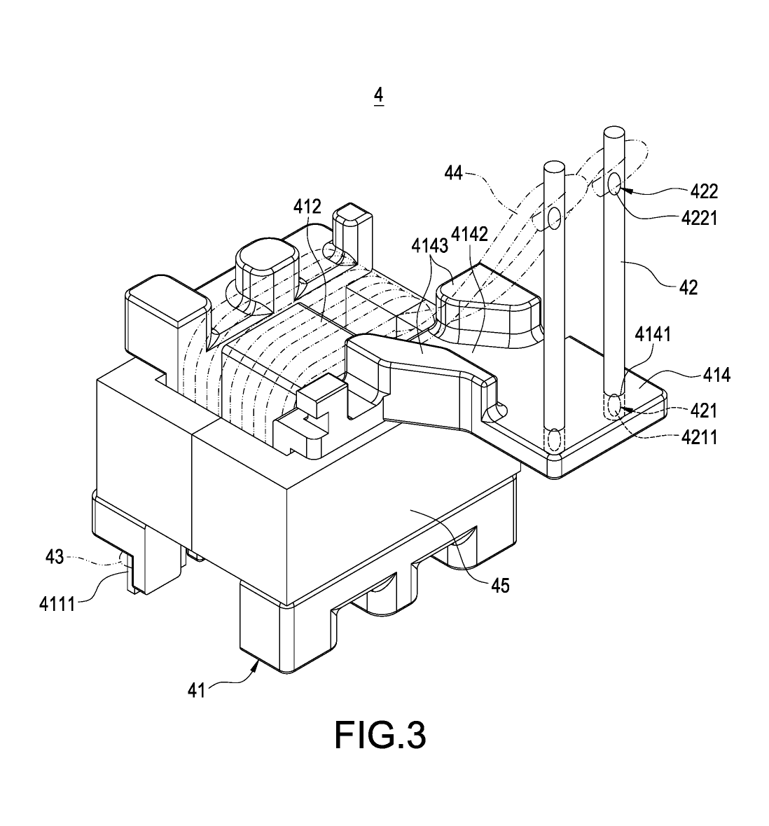

In step d of FIG. 1, as shown in FIGS. 2 and 3, an iron core set 45 is provided, a portion of the iron core set 45 is inserted and engaged inside the channel 413, and another portion of the iron core set 45 surrounds the exterior of the winding portion 412.

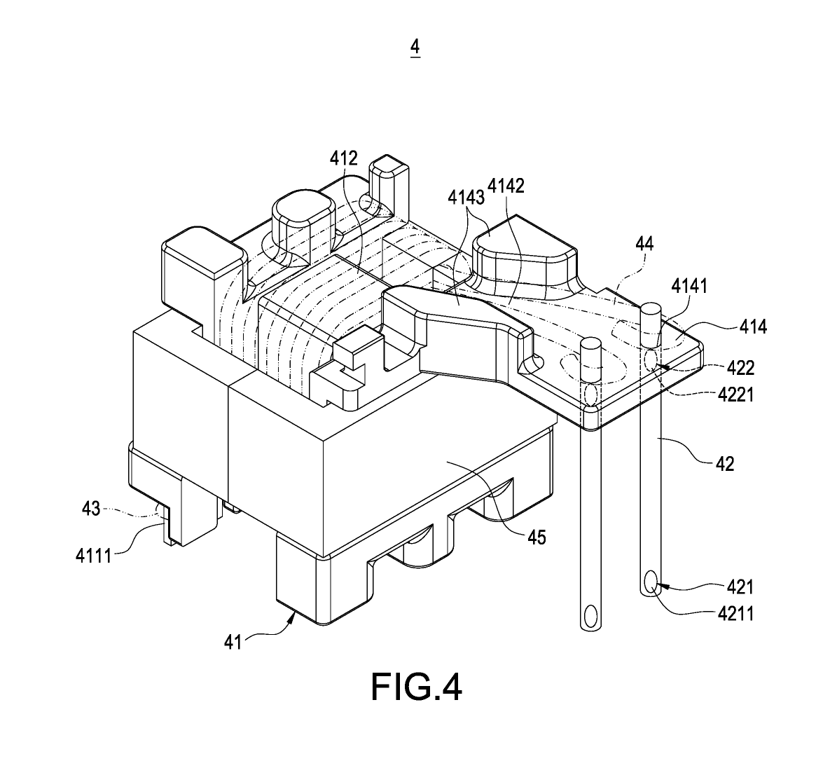

In step e of FIG. 1, as shown in FIGS. 3 and 4, a fixture (not illustrated) is provided. The fixture (not illustrated) further inserts the movable pin 42 into the through hole 4141 once again until the first latch portion 421 deforms or is damaged. The first latch portion can no longer engage the protruding plate 414 and thereby releases the movable pin 42, and the second latch portion 422 is then engaged with the through hole 4141.

Furthermore, as shown in FIGS. 2 to 4, a wiring groove 4142 is disposed on a top of the protruding plate 414 and arranged in a direction from the winding portion 412 toward the through hole 4141, two guiding blocks 4143 extend from the top of the protruding plate 414, and the wiring groove 4142 is formed between the two guiding blocks 4143. The wiring groove 4142 is used to receive the second winding 44, so that the second winding 44 is confined between the two guiding blocks 4143.

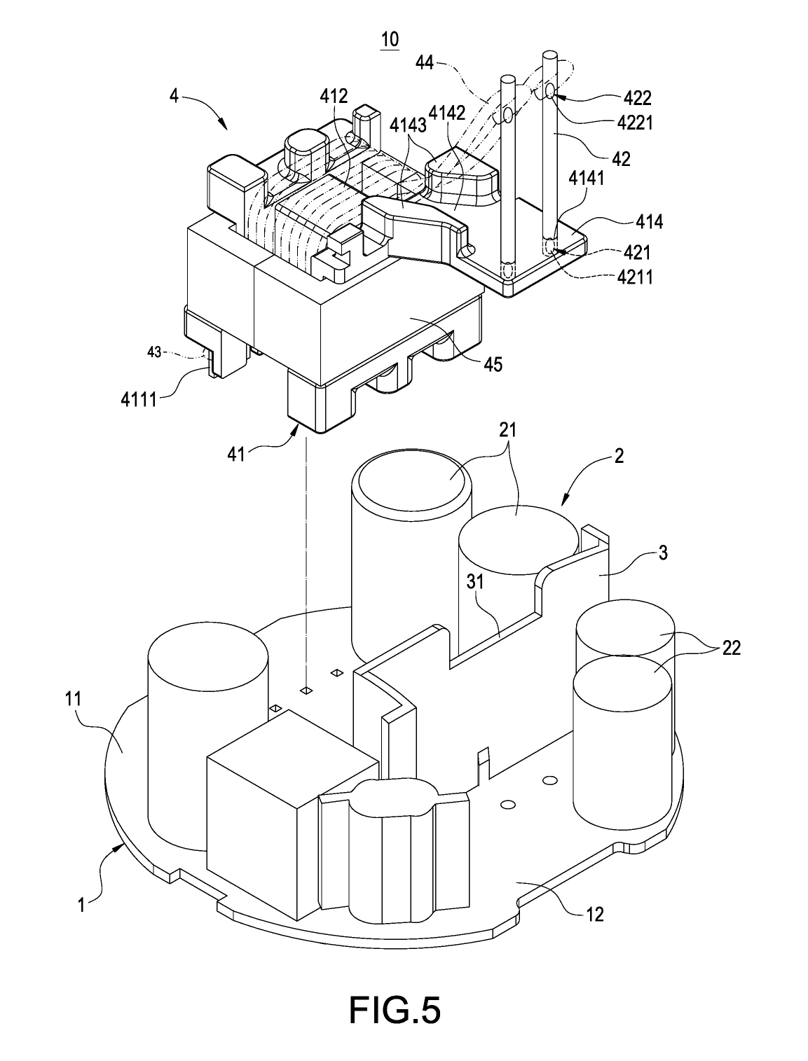

Please refer to FIGS. 5 to 8, illustrating assembling of the adapter 10. First, the circuit board 1 is divided into a primary area 11 and a secondary area 12. The current processing module 2 includes a plurality of primary components 21 and a plurality of secondary components 22. The primary components 21 are installed in the primary area 11 and are electrically connected to the circuit board 1. The secondary components 22 are installed in the secondary area 12 and are electrically connected to the circuit board 1.

Furthermore, since current adapter 10 is small-sized due to the product miniaturization trend, the primary component 21 is close to the secondary component 22. Therefore, by means of the shielding plate 3 inserted in the circuit board 1 and arranged between the primary area 11 and the secondary area 12, i.e. the shielding plate 3 being arranged between the primary components 21 and the secondary components 22, the shielding plate 3 separates the primary components 21 from the secondary components 22 to prevent the primary components 21 and the secondary components 22 from affecting each other during operations. The shielding plate 3 is made of plastic or other suitable insulating material and includes a recess 31 indented from a top of the shielding plate 3.

Moreover, the adapter 4 is installed on the circuit board 1, so that the bobbin 41 is disposed at one side of the shielding plate 3 on the primary area 11, and the protruding plate 414 is engaged with the recess 31 to make the protruding plate 414 extends over the shielding plate 3 to the secondary area 12.

Finally, the connection pin 4111 is inserted and electrically connected to the primary area 11, and the primary component 21 is electrically connected to the first winding 43 through the circuit board 1 and the connection pin 4111, so that the primary component 21 can process the input current, and then transmit the processed current to the first winding 43. The movable pin 42 is inserted through the through hole 4141, the movable pin 42 is inserted and electrically connected to the secondary area 12, and the secondary component 22 is electrically connected to the second winding 44 through the circuit board 1 and the movable pin 42, so that the secondary component 22 can perform a subsequent process on the current output from the second winding 44.

In the present embodiment, the first winding 43 and the connection pin 4111 are electrically connected to the primary component 21, so the first winding 43 is a primary winding, and the connection pin 4111 is a primary pin. The second winding 44 and the movable pin 42 are electrically connected to the secondary component 22, so the second winding 44 is a secondary winding, and the movable pin 42 is a secondary pin. However, the present invention is not limited to the embodiment disclosed. Configurations may be modified according to requirement. In alternative embodiments, the first winding 43 can be a secondary winding, the connection pin 4111 can be a secondary pin, the second winding 44 can be a primary winding, and the movable pin 42 can be a primary pin.

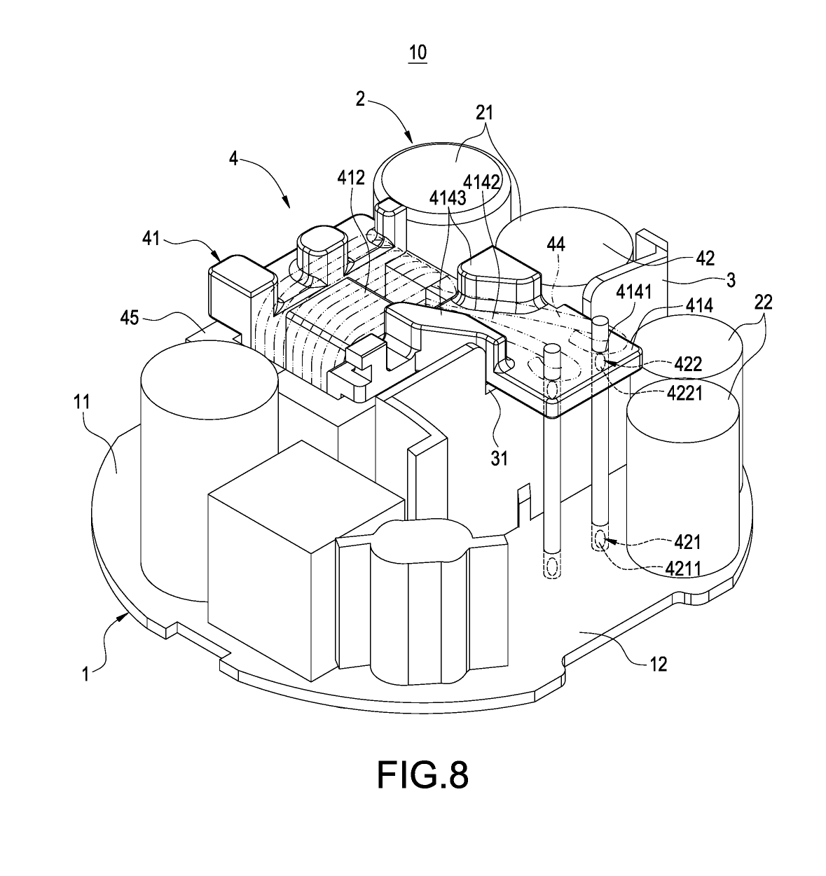

Furthermore, as shown in FIGS. 4 and 8, since the second latch portion 422 is disposed above the first latch portion 421, so the movable pin 42 is disposed at one side of the iron core set 45 when the second latch portion 422 is engaged and positioned in the through hole 4141. Furthermore, the first latch portion 421 is arranged away from the protruding plate 414. In other words, the first latch portion 421 is arranged close to the circuit board 1.

In conventional techniques, a second winding is directly welded to a circuit board by manual labor. By contrast, the adapter 10 and the transformer 4 can be assembled in an automatic process using a robot arm to complete the following procedures. The movable pin 42 is inserted in the through hole 4141 and is positioned there by engagement of the first latch portion 421 or the second latch portion 422 with the through hole 4141. The iron core set 45 is assembled to the bobbin 41, the second winding 44 is connected to the movable pin 42 by means of welding or adhesives. The transformer 4 is installed on the circuit board 1, the bobbin 41 is disposed on the primary area 11, the protruding plate 414 extends over the shielding plate 3 to the secondary area 12, the first latch portion 421 deforms or is damaged to release the movable pin 42, and the movable pin 42 is then inserted in the secondary area 12. Thus, through the automatic process, manual labor costs are reduced, assembly efficiency is enhanced, and production yields are improved.

Furthermore, as shown in FIGS. 2 to 4, after assembly, the movable pin 42 is disposed at one side of the iron core set 45. If, during assembly, the movable pin 42 is fixed and immobile at one side of the iron core set 45 in the beginning, it is not possible to wind the winding and install the iron core set 45. Therefore, the movable pin 42 is designed to be movable and is positioned by means of the first latch portion 421 and the second latch portion 422, so that the winding can be wound and the iron core set 45 can be installed smoothly.

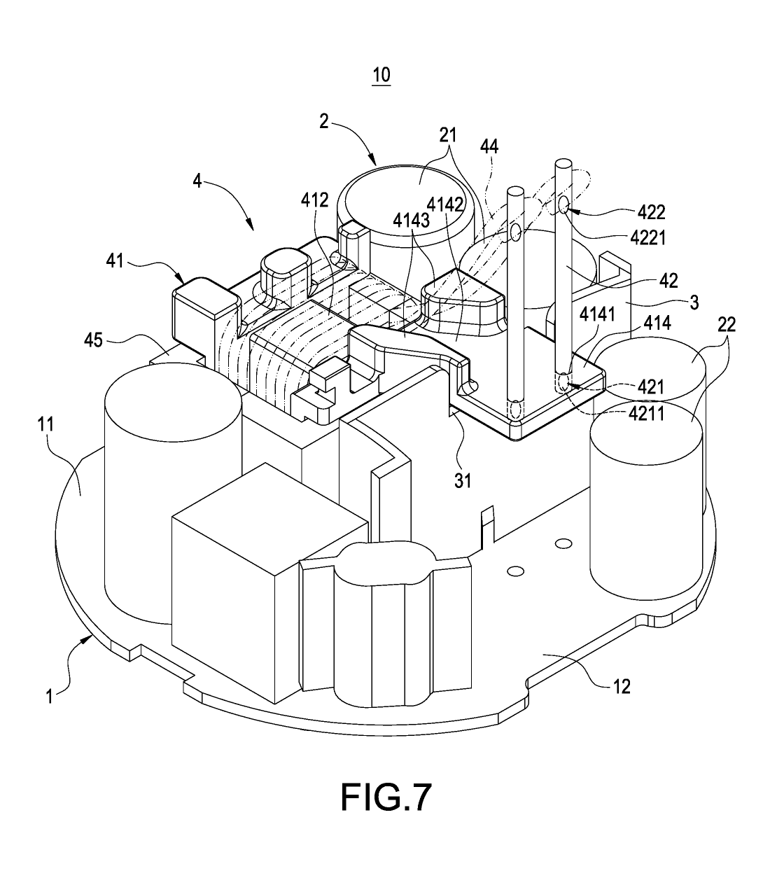

Moreover, as shown in FIGS. 7 and 8, due to the product miniaturization trend, the adapter 10 is small-sized, and as a result, the primary pin is too close to the secondary pin, which fails to provide for a minimum insulation clearance as required by safety regulations. Therefore, in order to provide for an insulation clearance as required by the safety regulations for the small-sized adapter 10, the protruding plate 4141 is arranged to increase a distance between the connection pin 4111 and the movable pin 42 (one of them is the primary pin while the other one is the secondary pin) of the transformer 4.

Moreover, the movable pin 42 is disposed in the transformer 4 at one side. It should be noted that, in alternative embodiments, one movable pin 42 may be disposed at one side while another movable pin 42 is disposed at the other side, and this modification is still within the protection scope of the present invention.

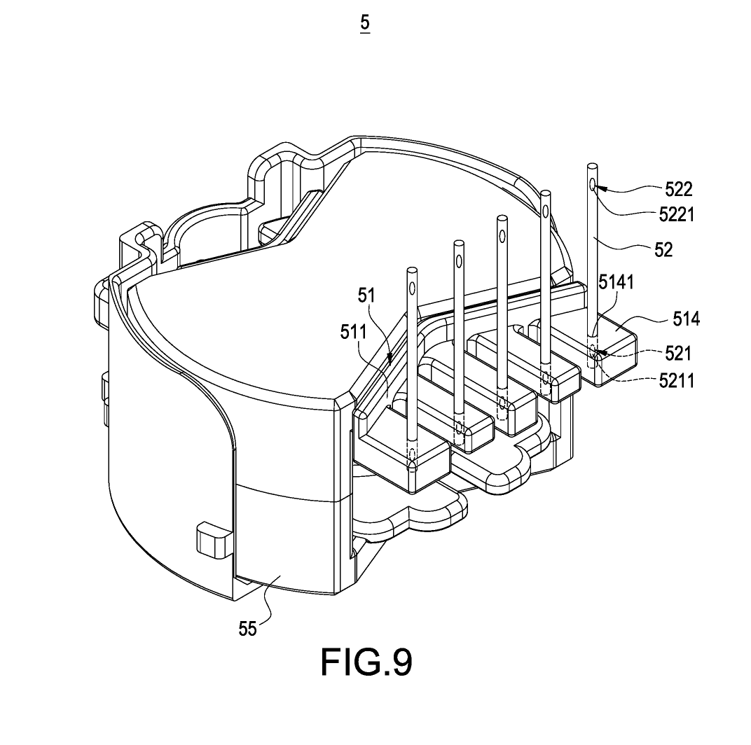

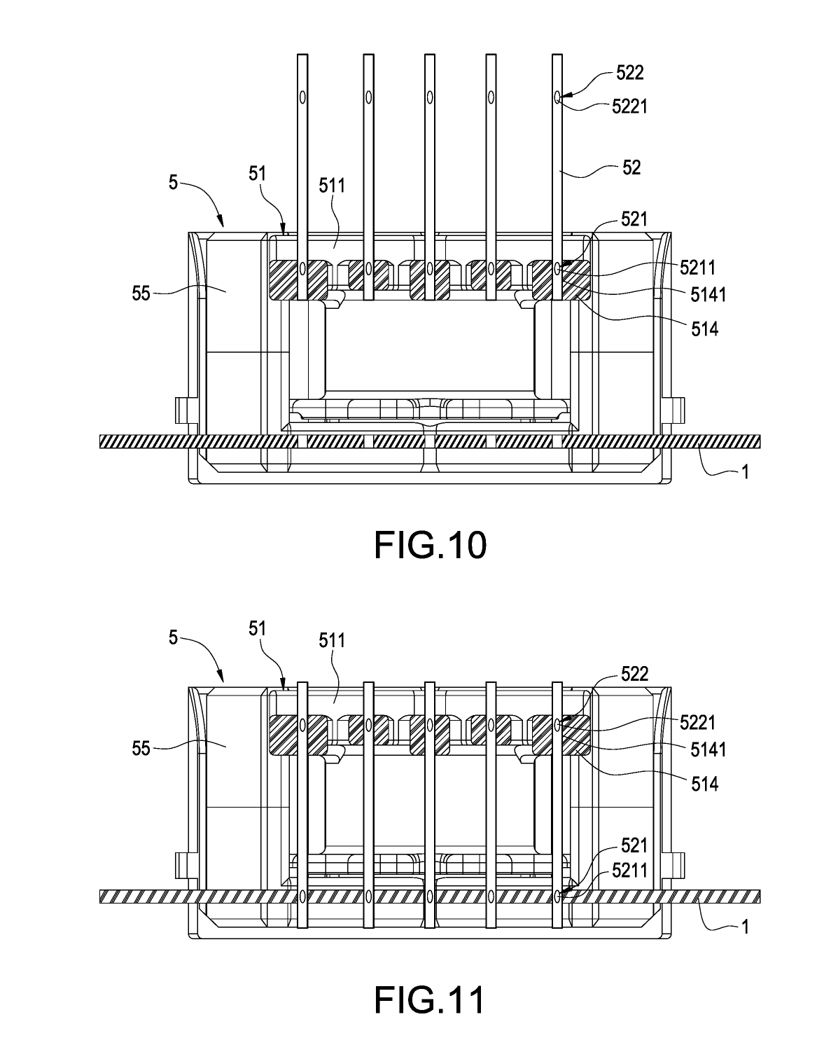

In detail, as shown in FIGS. 2 to 4, in the present embodiment, although the connection pin 4111 is a fixed pin, the present invention is not limited to this particular form, and the connection pin 4111 can also be a movable type pin. If there are two protruding plates 414 extending from the two side walls 411 of the bobbin 41 respectively, the connection pin 4111 can be a movable type pin (similar to the structure of the movable pin 42) instead to be inserted in the through hole 4141 of the protruding plate 414. Please refer to FIGS. 9 to 11 illustrating the transformer according to another embodiment of the present invention. The embodiment is similar to the embodiment shown in FIGS. 1 to 8. This embodiment is different from the previous embodiment shown in FIGS. 1 to 8 in that the transformer in FIGS. 9 to 11 is a vertical transformer while the transformer in FIGS. 1 to 8 is a horizontal transformer.

In detail, the transformer 5 in this embodiment is a vertical transformer. Whether the transformer 5 is a vertical transformer or a horizontal transformer, the protruding plate 514 extends from the side wall 511 of the bobbin 51 and includes the through hole 5141. The movable pin 52 includes the first latch portion 521 and the second latch portion 522. The movable pin 52 is inserted into the through hole 5141 until the first latch portion 521 is engaged and positioned in the through hole 5141. The second winding (not illustrated) is connected to the movable pin 52. The movable pin 52 is then further inserted into the through hole 5141 to cause deformation or damage of the first latch portion 521, and the movable pin 52 is thereby released until the second latch portion 522 is engaged and positioned in the through hole 5141, thus carrying out the same functions as the embodiment shown in FIGS. 1 to 8. After assembly, the movable pin 52 is disposed at one side of the iron core set 55.

Moreover, the first latch portion 521 is a first pattern 5211 on the movable pin 52, and the second latch portion 522 is a second pattern 5221 on the movable pin 52; however, the present invention is not limited in this regard. The first latch portion 521 and the second latch portion 522 can be, for example, adhesives or protruding points on the movable pin 52.

In summary, the adapter, the transformer, the bobbin, and the assembly method of the transformer of the present invention can achieve anticipated objectives and solve the conventional defects. The present invention also has industrial applicability, novelty and non-obviousness, so the present invention completely complies with the requirements of patentability. Therefore, a request to patent the present invention is filed pursuant to patent law. Examination is kindly requested, and allowance of the present application is solicited to protect the rights of the inventor.

What is claimed is:

1. An adapter, comprising:
a circuit board;
a current processing module including a plurality of primary components and a plurality of secondary components installed and electrically connected to the circuit board;
a shielding plate disposed between the primary components and the secondary components; and
a transformer installed on the circuit board, the transformer comprising:
a bobbin disposed at one side of the shielding plate, the bobbin including two side walls and a winding portion arranged between the two side walls, a protruding plate extending from one of the side walls and passing through the shielding plate, at least one through hole being defined on the protruding plate, a connection pin being arranged on the other side wall, the connection pin being inserted in the circuit board;
at least one movable pin inserted through the through hole and inserted in the circuit board, the movable pin including a first latch portion and a second latch portion, the second latch portion being engaged and positioned in the through hole, the first latch portion being disposed adjacent to the circuit board;
at least one first winding wound around the winding portion and connected to the connection pin; and
at least one second winding wound around the winding portion and connected to the movable pin.

2. The adapter according to claim 1, wherein a channel communicating with the inside of the winding portion passes through the two side walls, the channel is arranged below the protruding plate, the transformer includes an iron core set, a portion of the iron core set is inserted and engaged inside the channel, and another portion of the iron core set surrounds the exterior of the winding portion.

3. The adapter according to claim 2, wherein the second latch portion is disposed above the first latch portion, the movable pin is disposed at one side of the iron core set, the first latch portion is a first pattern formed on the movable pin, and the second latch portion is a second pattern formed on the movable pin.

4. The adapter according to claim 2, wherein the circuit board is divided into a primary area and a secondary area, the shielding plate is inserted in the circuit board and is disposed between the primary area and the secondary area, the primary components and the connection pin are installed and electrically connected to the primary area, and the secondary components and the movable pin are installed and electrically connected to the secondary area.

5. The adapter according to claim 4, wherein the shielding plate includes a recess indented from a top of the shielding plate, and the protruding plate is engaged with the recess.

6. The adapter according to claim 4, wherein a wiring groove is disposed on a top of the protruding plate and arranged in a direction from the winding portion toward the through hole, two guiding blocks extend from the top of the protruding plate, and the wiring groove is formed between the two guiding blocks.

7. A transformer, comprising:
a bobbin including two side walls and a winding portion arranged between the two side walls, a protruding plate extending from one of the side walls, at least one through hole being defined on the protruding plate, a connection pin being arranged on the other side wall;
at least one movable pin inserted through the through hole, the movable pin including a first latch portion and a second latch portion, the second latch portion being engaged and positioned in the through hole, the first latch portion being disposed away from the protruding plate;
at least one first winding wound around the winding portion and connected to the connection pin; and
at least one second winding wound around the winding portion and connected to the movable pin.

8. The transformer according to claim 7, wherein a channel communicating with the inside of the winding portion passes through the two side walls, the channel is arranged below the protruding plate, the transformer includes an iron core set, a portion of the iron core set is inserted and engaged inside the channel, and another portion of the iron core set surrounds the exterior of the winding portion.

9. The transformer according to claim 8, wherein the second latch portion is disposed above the first latch portion, the movable pin is disposed at one side of the iron core set, the first latch portion is a first pattern formed on the movable pin, and the second latch portion is a second pattern formed on the movable pin.

10. The transformer according to claim 8, wherein a wiring groove is disposed on a top of the protruding plate and arranged in a direction from the winding portion toward the through hole, two guiding blocks extend from the top of the protruding plate, and the wiring groove is formed between the two guiding blocks.

11. An assembly method of a transformer, comprising the following steps:
a) providing a bobbin which has two side walls and a winding portion arranged between the two side walls, wherein a channel communicating with the inside of the winding portion passes through one of the side walls, a protruding plate extends from a top of this side wall, at least one through hole is defined on the protruding plate, and at least one connection pin is arranged on the other side wall;
b) providing at least one movable pin which includes a first latch portion and a second latch portion, inserting the movable pin into the through hole until the first latch portion is engaged with the through hole;
c) providing at least one first winding and at least one second winding, wherein the at least one first winding is wound around the winding portion and connected to the connection pin, and the at least one second winding is wound around the winding portion and connected to the movable pin;
d) providing an iron core set, wherein a portion of the iron core set is inserted and engaged inside the channel, and another portion of the iron core set surrounds the exterior of the winding portion; and
e) providing a fixture, the fixture further inserting the movable pin into the through hole until the first latch portion deforms or is damaged to thereby release the movable pin, and the second latch portion is then engaged with the through hole.

12. The assembly method of the transformer according to claim 11, wherein in step b), the first latch portion is a first pattern formed on the movable pin, and the second latch portion is a second pattern formed on the movable pin; in step e), the second latch portion is disposed above the first latch portion, and the movable pin is arranged at one side of the iron core set.

13. A bobbin, comprising:
two side walls and a winding portion arranged between the two side walls, a protruding plate extending from one of the side walls, at least one through hole being defined on the protruding plate; and
at least one movable pin inserted through the through hole, the movable pin including a first latch portion and a second latch portion, the second latch portion being engaged and positioned in the through hole, and the first latch portion being disposed away from the protruding plate.

14. The bobbin according to claim 13, wherein the second latch portion is disposed above the first latch portion, the first latch portion is a first pattern formed on the movable pin, and the second latch portion is a second pattern formed on the movable pin.

15. The bobbin according to claim 13, wherein a wiring groove is disposed on a top of the protruding plate and arranged in a direction from the winding portion toward the through hole, two guiding blocks extend from the top of the protruding plate, and the wiring trench is formed between the two guiding blocks.
